(19) United States
(12) Patent Application Publication
(10) Pub. No.: US 2022/0408636 A1
(43) Pub. Date: Dec. 29, 2022

(54) SICKLE SECTION AND KNIFEBACK AND SECTION JOINT

(71) Applicants: Joseph W. Schaffer, Colgate, WI (US); Neal J. Stoffel, Campbellsport, WI (US)

(72) Inventors: Joseph W. Schaffer, Colgate, WI (US); Neal J. Stoffel, Campbellsport, WI (US)

(73) Assignee: Kondex Corporation, Lomira, WI (US)

(21) Appl. No.: 17/359,189

(22) Filed: Jun. 25, 2021

(51) Int. Cl. A01D 34/14

(52) U.S. Cl. CPC A01D 34/14

(57) ABSTRACT

A knifeback for mounting a plurality of sickle cutting sections along a length of the knifeback. The knifeback includes an elongated knifeback bar comprising a first bar surface and a second bar surface. A plurality of bar apertures extending through the first and second bar surfaces are arranged to facilitate side-by-side mounting of the sickle cutting sections. A plurality of annular mounts are along the first bar surface. Each of the annular mounts is offset from and in surrounding relation of a respective member of the plurality bar apertures.

This invention generally relates to agricultural parts, and more specifically to sickle bar assemblies and their mating parts of knifebacks, sickle cutting sections, and knife heads.

### BACKGROUND OF THE INVENTION

Typical sickle bar assemblies include a knifeback, also referred to as a sickle bar, and sickle cutting sections, also referred to as knives, and knife heads. A knife head can be mounted onto the knifeback to drive the knifeback back and forth in reciprocating motion. As the knifeback is driven in a reciprocating fashion its knives move over knife guards to cut a crop or other organic growth. Typically, sickle bar assemblies are used in harvesters, mowers or other commercial or even residential machines. Various examples of the sickle bar assemblies and their components are disclosed, for example, in U.S. Pat. Nos. 4,854,114; 8,371,096 and 6,467,246, the entire teachings of which are incorporated herein by reference.

### BRIEF SUMMARY OF THE INVENTION

Embodiments of the invention may improve the useful life of a sickle bar assembly by improving the useful life of any one of or combinations of parts that make up the sickle bar assembly, namely, the knifeback, the sickle cutting sections; and/or the knife head.

The part mating robustness and/or improved useful life of each part and thus the sickle bar assembly may be achieved through the mechanical interlocking of the mating parts. By mating parts it is meant the sickle cutting section that mates with the knife back; and the knife head that mates directly with the knifeback; or the knife head that mates with a top surface of the sickle cutting section which in turn mates with the knifeback to drive the sickle bar assembly.

The part mating robustness may improve fatigue strength in the knifeback, the sickle cutting section, and the knife head and in fasteners that may be used to connect them and thereby the useful life of each part and thus the sickle bar assembly may be improved.

Locating and joining mating parts using the annular mounts that provide a mechanical interlock may provide fatigue strength because of the ability the annular mounts of the knifeback to bear part of the load that had been carried by bolts joining the mating the parts. This may enhance the sickle bar assembly's ability to support transverse, longitudinal, diagonal, and bending loads.

Part-to-part mating via the mechanical interlocking may reduce fretting and joint clamp load vulnerability through the joint's increased friction and load handling capability. Bearing surface area and characteristics may spread and space the sickle cutting bar assembly's loads over greater surface areas reducing reliance on fastener clamp load alone. Less reliance on clamp load and more on the mechanical interlock of mating parts in reciprocating motion means the fastener or fasteners joining the mating parts no longer carries system working loads that may ultimately result in fracture origins in the knifeback, sickle cutting section, knife head or fasteners.

The sickle cutting sections or knifebacks or knife heads that heretofore have been described and will be described hereafter, may be used in a method that provides for them to be used individually or in combination as replacement parts in the field to improve the useful life of the parts and in turn the sickle bar assemblies that they form.

A cold forming process applied to the knifeback reduces the sharpness of the surface at the opening of the apertures of the knifeback. The sharpness at opening of the apertures may be reduced because the cold forming process that rounds the edge. Rounding the edge around the aperture may reduce the stress riser of the previously sharp edge and thus may improve the fasteners and apertures useful lives by improving their fatigue life.

According to one inventive aspect, a knifeback comprises a plurality of annular mounts that may be used for mounting a plurality of sickle cutting sections along a length of the knifeback. The knifeback comprises an elongated knifeback bar that includes a first bar surface and a second bar surface. A plurality of bar apertures extend through the first and second bar surfaces and are arranged to facilitate side-by-side mounting of the sickle cutting sections. The annular mounts are along the first bar surface. Each of the annular mounts is offset from and in surrounding relation of a respective member of the plurality bar apertures.

According to another inventive aspect, a knifeback comprises annular mounts may be (a) annular channels, or (b) annular ribs, or (c) a combination of annular channels and annular ribs. The elongated knifeback bar has a first bar surface and a second bar surface. The elongated knifeback bar has a drive end and a distal end. A row of bar apertures extend through the first and second bar surfaces. A plurality of annular mounts may be along the first bars surface.

Any of the following features below may be used alone or in combination with other of the below features with either or both the above inventive aspects of the knifeback.

Each of the annular mounts may include an annular rib. The annular rib may have an outer wall and an inner wall connected at a rib tip. The rib tip may be pointed or rounded.

Each of the annular mounts may include an annular channel having an inner wall and an outer wall connected at a channel bottom.

Preferably, each of the annular mounts may be a continuous uninterrupted ring structure extending 360 degrees around the respective one of the plurality of bar apertures.

Optionally, each of the annular mounts may be discontinuous and made up of spaced segments in a shape of a ring.

An innermost location of each annular mount may be spaced at least 1 millimeter from an outermost location of the respective one of the plurality of bar apertures.

Along the first bar surfaces there may be regions radially inside of and outside of each of the annular mounts that are substantially coplanar.

The annular mount may be a V-shaped cross-section.

The annular mount may alternatively be a U-shaped cross section. However a V-shape with converging radially inward and outwardly surfaces may optionally be compressed during clamping of fasteners and more directly facilitate load transfer when clamped.

Each of the annular mounts may be sized to be received into a complimentary annular channel of a sickle cutting section to provide a mechanical interlock between the knifeback and the sickle cutting section.

Each of the annular mounts may be sized to receive a complimentary annular rib of a sickle cutting section to provide a mechanical interlock between the knifeback and the sickle cutting section.

Each of the annular mounts may have an outer diameter that is at least 50% more than a diameter of the respective one of the plurality of bar apertures that it surrounds.

Each of the annular ribs may have a maximum width of between 0.5 and 3 millimeters and a maximum height measured in a direction extending away from the first bar surface and the second bar surface of no greater than 50% of a bar thickness between the first bar surface and the second bar surface.

Each annular channel may have a maximum width of between 0.5 and 3 millimeters and a maximum depth measured from the first bar surface towards the second bar surface of no greater than 50% of a bar thickness between the first bar surface and the second bar surface.

The annular channel may be cold pressed into the first bar surface or the first bar surface may be machined to define the annular channel.

The annular rib may have an outer diameter at least 50% more than an outer diameter of a respective one of the plurality of apertures that it surrounds.

The annular rib may be defined by machining or stamping, or by an insert, or by deposition of a cladding.

Each annular mount may have a maximum width of between 0.5 and 3 millimeters and a maximum elevation span away from substantially coplanar regions of the first bar surface of between 0.05 millimeters and 1.5 millimeters, and is spaced away from the bar apertures by at least 1 millimeter.

A plurality of sickle mounting locations may be arranged in side by side relation along a length of the elongated knifeback bar. Each sickle mounting location may include at least one annular mount and at least one bar aperture.

Each annular mount typically is in surrounding relation of a respective member of the bar apertures.

The annular mounts preferably are offset in spaced relation from the bar apertures.

Each sickle mounting location may include two of the bar apertures and two of the annular mounts including a first mount surrounding a first bar aperture, and a second mount surrounding a second bar aperture.

For the knifeback, the drive end may include drive mounting apertures. A portion of the drive end with at least some of the drive mounting may have the annular mounts.

The knifeback can be incorporated into a sickle bar assembly that includes the knifeback in combination with a plurality of sickle cutting sections. Each of the sickle cutting section may have a first annular section mount and further include a plurality of fasteners. At least one of the plurality of fasteners secures a corresponding member of the plurality of sickle cutting sections to the sickle bar. Each corresponding member of the plurality of the sickle cutting sections is mechanically interlocked via the annular mount an the first annular section mount.

The first surface may include cold formed and plastically deformed rounded bearing surfaces at the opening of each one of the plurality of bar apertures at the first bar surface to reduce a bolt load when a bolt is inserted therethrough.

Each the first annular section mounts may have a maximum width of between 0.05 and 3 millimeters and a maximum elevation span away from the first surface of between 0.05 millimeters and 3 millimeters.

Each annular mount may have a radially inwardly facing support surface and a radially outward facing support surface that are connected at an annular joint.

The radially outward facing support surface and the radially inwardly facing support surface may converge toward each other toward the annular joint.

The annular mounts may be provided by annular inserts. Annular channels may defined into the first bar surface. Each annular insert may be mounted in a member of the annular channels.

The annular inserts may project from the annular channels and beyond the first bar surface to provide annular ribs as the annular mounts.

The annular inserts may be removably mounted in the annular channels. The knifeback may include an assembly of the knifeback bar in combination with the annular inserts.

Each annular insert may be a disc including at least one annular wedge projection extending from at least one of opposed flat sides of the flat annular disc transversely relative to the first bar surface, and optionally both opposed flat sides.

Each annular insert may be a profiled ring including upper and lower annular wedge projections projecting transversely relative to the first bar surface.

The annular mounts may be provided by annular inserts at the mounting locations. The annular insert channels may be defined into the first bar surface. Each annular insert may be mounted in a member of the annular insert channels.

The annular inserts may project from the annular insert channels and beyond the first bar surface to provide the annular ribs as the annular mounts.

The annular inserts may be removably mounted in the annular insert channels. The knifeback may include an assembly of the knifeback bar in combination with the annular inserts.

Another inventive aspect is directed toward a sickle cutting section. The sickle cutting section comprises a sickle plate that includes a first surface and a second surface. The sickle plate extends forwardly between an end of the sickle plate to a tip of the sickle plate with a plate thickness being defined between the first surface and the second surface.

The sickle plate includes a knifeback mounting portion that extends a partial distance from the end toward the tip. The knifeback mounting portion includes a first mounting aperture. A wedge portion extends from the mounting portion to the tip of the plate. The wedge portion may define a pair of knife cutting edges on opposite sides of the wedge portion that converge toward the tip. The first surface of the plate along the knifeback mounting portion comprises at least one annular section.

Any of the following features below may be used alone or in combination with other of the below features with either or both the above inventive aspects of the sickle cutting section.

For the sickle cutting section, the at least one annular section mount may include a first annular section mount that is offset in spaced relation from the first mounting aperture.

For example, the first annular section mount may comprise an annular rib.

For example, the first annular section mount may comprise an annular channel.

The first annular section mount may be in surrounding relation of the first mounting aperture.

The knifeback mounting portion preferably includes a second mounting aperture and a second annular section mount. The second the second annular section mount is offset in spaced relation from the second mounting aperture

The first annular section mount may be in surrounding relation of and offset from the first mounting aperture. The second annular section mount may be in surrounding relation of and offset from the second mounting aperture.

Each annular section mount may have a radially inwardly facing support surface and a radially outward facing support surface that are connected at an annular joint.

The radially outward facing support surface and the radially inwardly facing support surface may converge toward each other toward the annular joint.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a top side isometric view of a sickle bar assembly and knife head according to the teachings of the instant application;

FIG. 2 is an isometric assembly view of the sickle bar assembly of FIG. 1,

FIG. 3 is an isometric top view of the knifeback of FIG. 1;

FIG. 4 is an isometric partial bottom view of the area around a bar aperture of the knifeback of FIG. 1;

FIG. 5 is a cross section of the knifeback take about line 6-6 of FIG. 3;

FIG. 6 is a schematic illustration of a top view of a knifeback according to another embodiment of a knifeback;

FIG. 7 is a schematic partial cross sectional view of another embodiment of a knifeback having an annular mount with a U-shaped cross section;

FIG. 8 is a schematic partial cross sectional view of another embodiment of a knifeback having an annular mount that is a rib;

FIG. 9 is a schematic partial top view of another embodiment of a knifeback;

FIG. 10 is a schematic bottom view of the knifeback of FIG. 9;

FIG. 11 is an isometric bottom view of the sickle cutting section of FIG. 1;

FIG. 12 is a partial vertical cross-section of the sickle bar assembly taken about line 12-12 of FIG. 1 without the washers and bolts illustrated;

FIG. 13 illustrates a schematic bottom view of the knife head of FIG. 13; and

FIG. 14 illustrates an isometric view of an insert for the knifeback of FIG. 3;

FIG. 15 is a vertical cross section of the insert of FIG. 14 taken about line A-A of FIG. 14;

FIG. 16 is an isometric view of another embodiment of an insert for the knifeback of FIG. 3;

FIG. 17 is vertical cross section of the insert of FIG. 16 taken about line B-B of FIG. 16;

FIG. 18 is a cross section as in FIG. 12 but incorporating an insert in the knifeback bar.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

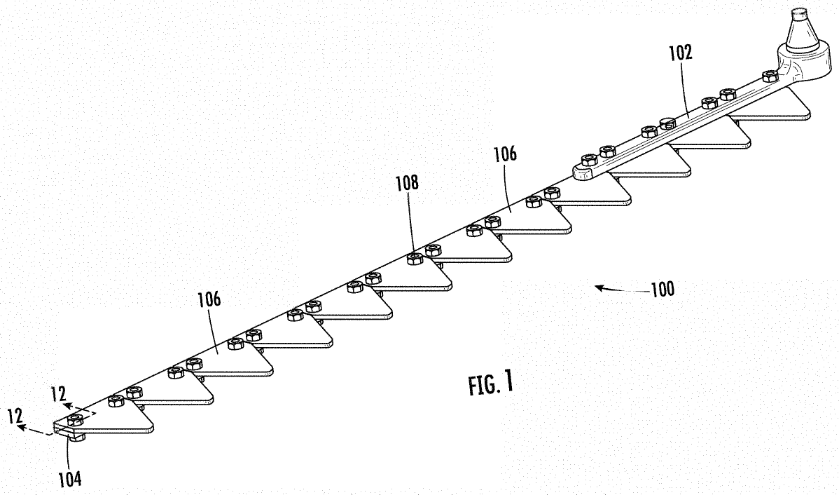

FIG. 1 is a top view of a sickle bar assembly 100 with a knife head 102 according to an embodiment of the present invention. The sickle bar assembly 100 includes a knifeback 104 and a plurality of sickle cutting sections 106 mounted to the sickle bar 102 along its length with fasteners 108 (for example, shoulder bolts). The knife head 102 joins to the sickle bar assembly 100 to drive the knifeback 104. Typically, the knifeback 104, the sickle cutting sections 106 and the knife head 102 are made from steel or alloy steel.

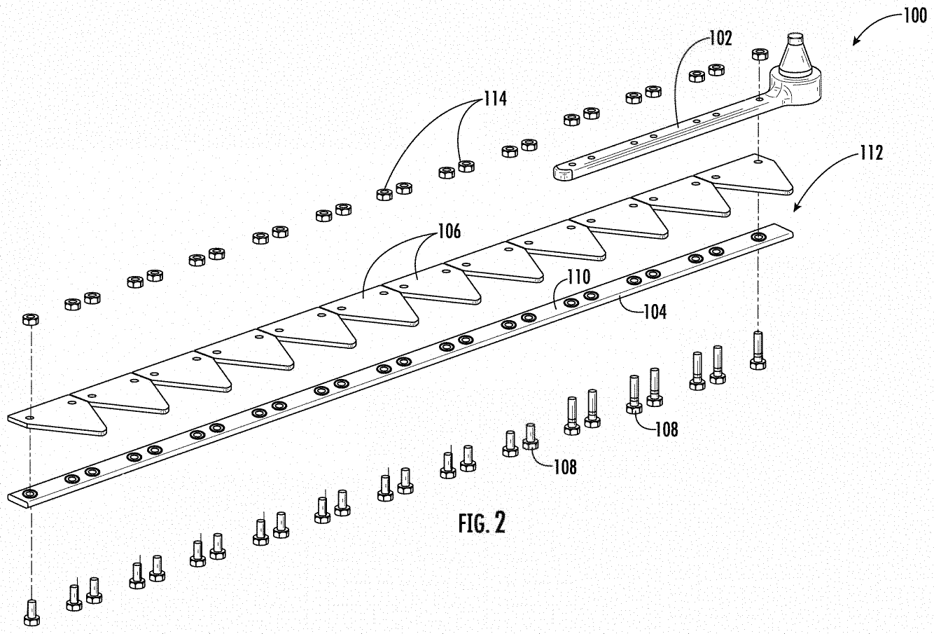

FIG. 2 is an assembly view of the sickle bar assembly 100 and knife head 102. The sickle cutting sections 106 mount along a first bar surface 110. The knife head 102 mounts over several of the sickle cutting sections 106 at a first bar end 112 of the knifeback 104 so as to connect to the knifeback 104 to the knife head 102. Alternatively, the knife head 102 could mount directly to the knifeback 104. In either case the fasteners 108, which may be bolts with nuts 114 (and optionally washers not shown) connect the knife head 102 to the knifeback 104 so that the knife head 102 can drive the knifeback 104 and its sickle cutting sections 106 in reciprocating motion.

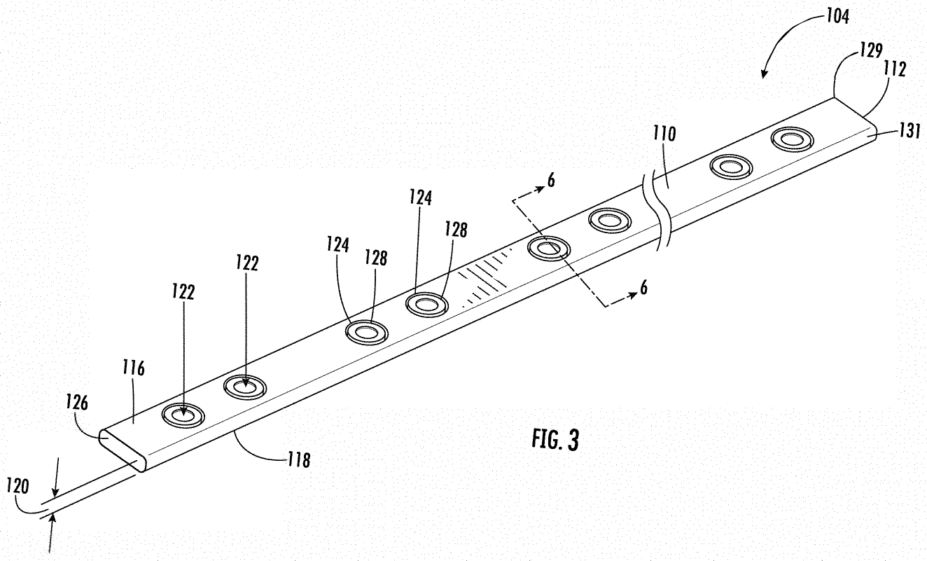

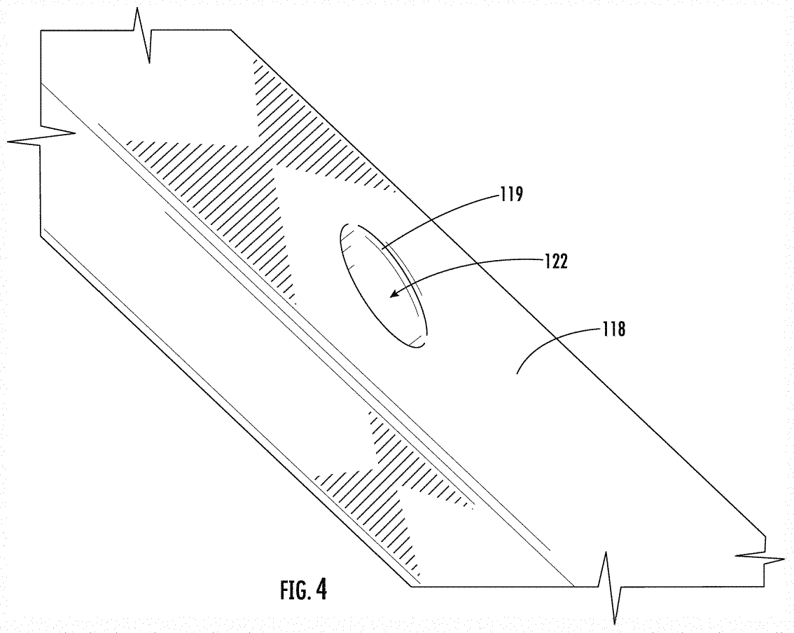

FIGS. 3 and 4 illustrate a top view and partial bottom view, respectfully, of the knifeback 104 of FIG. 1. The knifeback 104 is an elongated knifeback bar 116 that has a first bar surface 110 and a second bar surface 118 (e.g. top and bottom surfaces) with a bar thickness 120 defined between the first bar surface 110 and the second bar surface 118. A plurality of bar apertures 122 extend through the first bar surface 110 and the second bar surface 118 and are arranged, that is located, to facilitate mounting of the sickle cutting sections 106 (FIG. 1). Each bar aperture 122 may have a diameter between 3 to 8 millimeters. In a preferred embodiment each aperture 122 has a diameter between 4.7 to 6.4 millimeters.

As apparent from FIG. 2, multiple side-by-side sickle mounting locations are arranged in a row along the knifeback and each mounting location for example may be provided by a pair of bar apertures 122.

The first bar surface 110 and second bar surface 118 may include cold formed and plastically deformed rounded bearing surfaces 119 (see also, FIG. 4) at the opening of each one of the plurality of bar apertures 122 to reduce a bolt load when a fastener 108 (FIG. 2) is a bolt that is inserted therethrough.

For example, the deformed rounded bearing surfaces may has a radius of between 0.1 mm and 3 mm, and more preferably between 0.25 mm and 0.5 mm. Another way to characterize is that each rounded bearing surface may extend 1 millimeter from the cylindrical bore of its respective bar aperture 122 with a rounded profile that merges into the flat externally outward facing surface.

A plurality of annular mounts 124 are along the first bar surface 110. Preferably each one of the plurality of annular mounts 124 is offset from and in surrounding relations of a respective member of the plurality of bar apertures 122. In an embodiment, not illustrated, the respective member may include more than one of the plurality of annular mounts 124 for example in surrounding relation of a respective member of the bar apertures.

The knifeback 104 is typically of a length extending between the first bar end 112 and a second bar end 126 of between 0.3 and 15.3 meters, a width extending between a first side surface 129 and a second side surface 131 of between 1.3 and 10.6 cm and the bar thickness 120 of between 4.7 and 20 mm. More typically, the knifeback 104 length will be at least 4 meters, the width of at least 5 cm and the bar thickness of at least 10 mm. The knifeback 104 covers a span of at least five sickle cutting sections 106 (FIG. 1) but typically ten sickle cutting sections 106 or more.

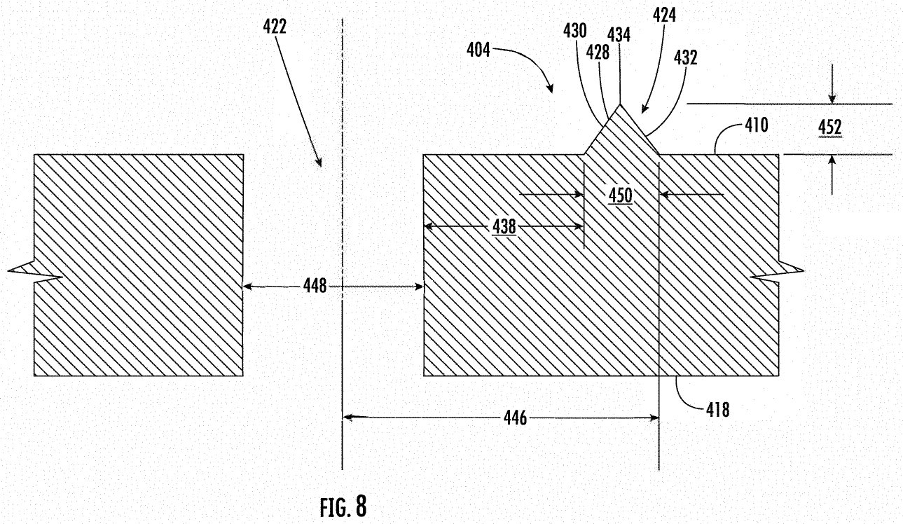

The knifeback 104 may be hardened by any known techniques such as, by way on a non-limiting example, heat treating, prior to or after the annular mounts 124 are pressed, machined or as will be discussed in the case of an annular mount 424 (FIG. 8) that is rib 428, that is an insert or formed from a buildup of clad. However, in other embodiments the knifeback 104 is not hardened prior to or after the annular mounts 124 are pressed, machined, inserted or cladded in/on the knifeback 104.

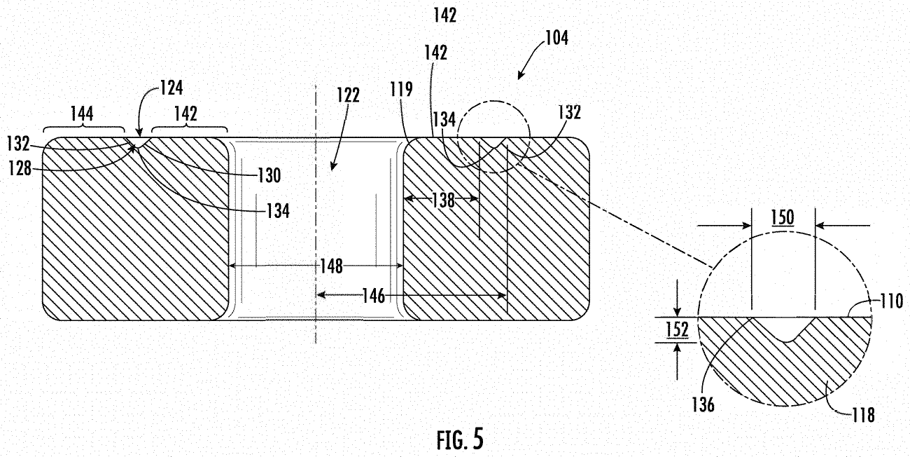

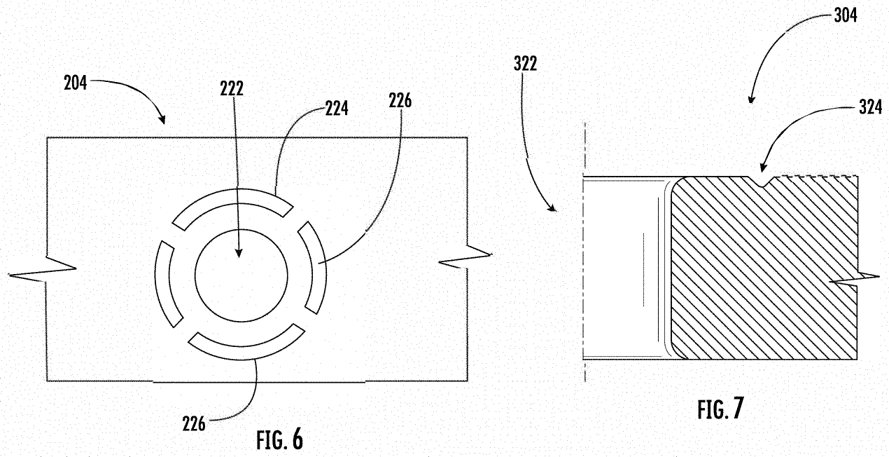

With reference now to FIG. 3. and FIG. 5, each of the annular mounts 124 of the knifeback 104 include an annular channel 128 having an inner wall 130 and an outer wall 132 connected at a channel bottom 134. Each of the annular mounts 124 is a continuous uninterrupted ring structure extending 360 degrees around the respective one of the plurality of bar apertures 122. Turning momentarily to FIG. 6, another embodiment of a knifeback 204 is illustrated in a plan view of a partial area taken over an aperture 222 and is similar to knifeback 104 except, each of the annular mounts 224 may be discontinuous with spaced segments 226 in the shape of a ring. Otherwise the same description for the other embodiments is applicable to this embodiment.

Turning again to FIGS. 3 and 5, an innermost location 136 of each annular mount 124 is spaced (distance 138) 0.25 millimeters from an outermost location 140 of the respective one of the plurality of bar apertures 122 and in a preferred embodiment is spaced at least 0.5 millimeters, and in a more preferred embodiment is spaced at least 1 millimeter. Along the first bar surface 110 are regions 142, 144 radially inside of and outside of each of the annular mounts 124 that are substantially coplanar. By “substantially” it is meant that there may be some degree of difference because of acceptable manufacturing tolerances in the knifeback 104 itself. The annular mounts 124 may have an outer diameter 146 that is at least 30 percent more than a diameter 148 of the annular mount 124.

Each annular channel 128 may have a maximum width 150 of between 0.5 and 3 millimeters and a maximum depth 152 measured from the first bar surface 110 towards the second bar surface 118 to the channel bottom 134 of no greater than 50% of the bar thickness 120 between the first bar surface 110 and the second bar surface 118. The annular channel 128 may be cold pressed into the first bar surface 110 or the first bar surface 110 may be machined to define each of the annular channels 128. The maximum channel depth 152 may also be referred to as an elevation span.

The annular mounts 124 may have V-shaped cross sections as illustrated which may be more preferred in that clamping via loading along converging surfaces can occur during tightening of fasteners.

Alternatively, turning to FIG. 7, a partial vertical cross section take through a bar aperture 322 and a knifeback 304 having annular mounts 324. Each annular mount 324 may have U-shaped cross sections that may be continuous or discontinuous as discussed above with respect to annular mount 124.

In another embodiment, FIG. 8 illustrates a partial vertical cross section taken through a bar aperture 422 of a knifeback 404 having annular mounts 424 that are annular ribs 428 that project axially away from a first bar surface 410 and a second bar surface 418. Each of the annular ribs 428 have an inner wall 430 and an outer wall 432 connected at a rib tip 434. Each of the annular ribs 428 may have a maximum width of between 0.5 and 3 millimeters and a maximum rib height 452, also referred to as elevation span, of between 0.5 millimeters and 1.5 millimeters as measured in a direction extending away from the substantially coplanar regions of the first bar surface 410 and the second bar surface 418. In light of the discussion above, it should be understood that “elevation span” may refer to the channel depth 152 of the annular mount 124 or the height of the ribs 428 above or below the substantially coplanar regions of the annular mounts 424.

The maximum rib height 452 may be of no greater than 50% of the bar thickness 420 between the first bar surface 410 and the second bar surface 418. The rib 428 may have a generally triangular cross section with the rib tip 434 that may be pointed to be received into V-shaped channel or rounded to be received in a U-shaped channel. The annular channel that is V-shaped channel (e.g. 128 at FIG. 5) provides a self-centering function that can be of assistance when mounting a sickle cutting section to the knife bar 404. It may also provide for load transfer particularly when clamped to facilitate loaded surface to surface contact.

The annular mount 424 is offset a distance 438 from the bar apertures 422 of at least 0.5 millimeters, and in a more preferred embodiment is spaced at least 1 millimeter. Each of the annular ribs 428 has an outer diameter 446 at least 50% more than an outer diameter 448 of each of the bar apertures 422 that it surrounds. Each of the annular ribs 424 may be the result of a method that includes machining the first bar surface 410 or stamping the first bar surface 410, or by an insert into the first bar surface 410, or by deposition of a cladding on and in some instances, given the melt zone created by laser cladding into the first bar surface 410.

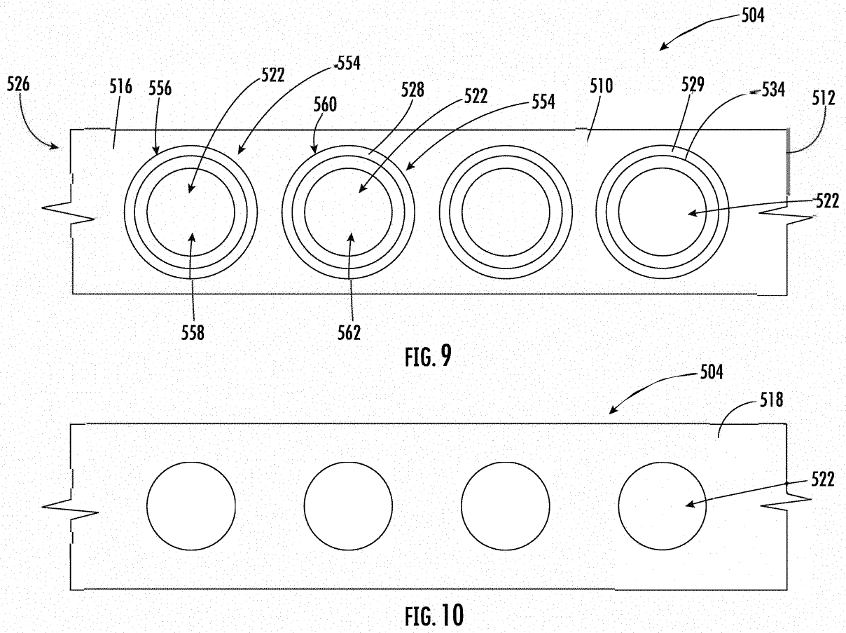

Turning to FIGS. 9 and 10, another embodiment of a knifeback 504 is schematically illustrated in a partial top view, FIG. 9, and bottom view FIG. 10. The knifeback 504 includes an elongated knifeback bar 516 comprising a first bar surface 510 and a second bar surface 518. The elongated knifeback bar 516 has a drive end 512 and a distal end 526. A row of bar apertures 522 extend between the driven end 512 and distal end 526. Each bar aperture 522 extends through the first bar surface 510 and the second bar surface 518. A plurality of annular mounts 524 are defined along the first bars surface 510. The annular mounts 524 may be annular channels 528 or annular ribs 529 or a combination of annular channels 528 and annular ribs 529.

A plurality of sickle mounting locations 554 may be arranged in side by side relation along a length of the elongated knifeback bar 516. Each sickle mounting location 554 may include at least one annular mount 524 and at least one bar aperture 522. Therefore, each sickle mounting location 554 may include more than one annular mount 524. Each annular mount 554 is in surrounding relation of a respective member of the bar apertures 522. Each of the annular mounts 524 is off set in spaced relation from the bar apertures 522.

Each of the sickle mounting location 554 may include two of the bar apertures 522 and two of the annular mounts 524 including a first mount 556 surrounding a first bar aperture 558, and a second mount 560 surrounding a second bar aperture 562. The drive end 512 may include the mounting apertures 522, wherein a portion of the drive end 512 with at least some of the drive mounting apertures 522 and the annular mounts 554 such that they can mate with complimentary sickle cutting section annular mounts or complimentary knife heads depending on whether there are sickle cutting sections between the knife head and the knifeback 504 or whether the knife head mounts directly on the knifeback 504.

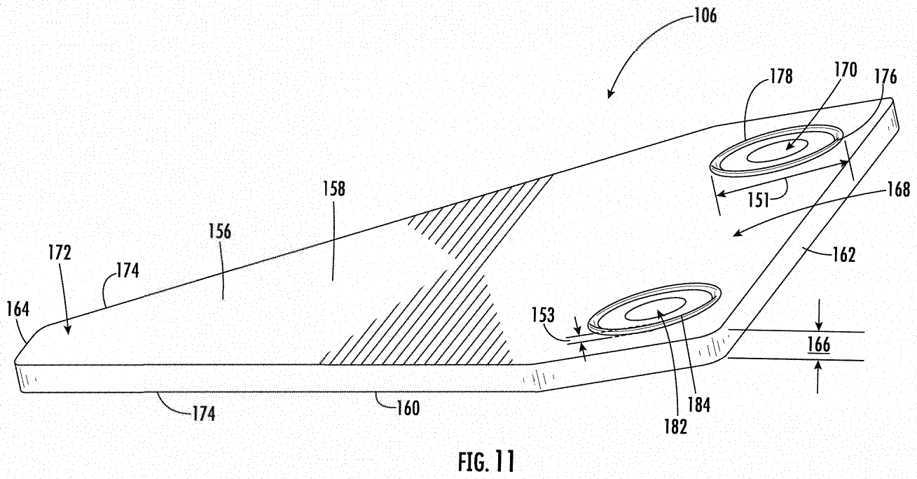

Turning to FIG. 11, a sickle cutting section 106 is illustrated. The sickle cutting section 106 includes a sickle plate 156 having a first surface 158 and a second surface 160. The sickle plate 156 extends forwardly between an end 162 of the sickle plate 156 to a tip 164 of the sickle plate 156. A plate thickness 166 is defined between the first surface 158 and the second surface 160.

The sickle plate 156 includes a knifeback mounting portion 168 that extends a partial distance from the end of the plate 162 to the tip 164 with the knifeback mounting portion 168 defining a first mounting aperture 170. A wedge portion 172 extends from the knife back mounting portion 168 to the tip 164 of the sickle plate 156. The wedge portion 172 defines a pair of knife cutting edges 174 on opposite sides of the wedge portion 172 that converge toward the tip 164.

The first surface 158 of the sickle plate 156 along the knifeback mounting portion 168 includes a first annular section mount 176. The first annular section mount 176 is offset in spaced relation from the first mounting aperture 170. As illustrated, the first annular section mount 176 comprises a knife annular rib 178 so as to be received into a complimentary shaped annular channel 128 as seen in FIGS. 3 and 5. Thus, as with annular channel 128, the annular rib 178 may have a V-shaped cross section as illustrated or U-shaped cross section depending on the annular channel 128 it will be received into. Thus, it should be readily apparent at this point in the description that the dimensions of the annular rib 178 and offset from the first mounting aperture 170 are the same as those described with respect to annular mounts 424 and annular ribs 428 that project axially away from the substantially coplanar regions of the first bar surface 410 in FIG. 8.

In another embodiment, the first annular section mount 176 may be a knife annular channel similar to annular channel 128 (FIGS. 3 and 5). The first annular section mount 176 may be continuous and surround the first mounting aperture 170 or may be discontinuous and surround the first mounting aperture 170 as described, for example, with respect to annular mount 224 of FIG. 6. The knife annular channel may have a V-shaped cross section or a U-shaped cross section as was described with respect to the annular channel 128 that was described with respect to FIG. 3 and FIG. 5. Here too, it should be readily apparent that the dimensions of the knife annular channel and its offset away from the first mounting aperture 170 and its depth and width may be the same as that which was described with respect to the annular channel 128.

More specifically each the first annular section mounts 176 has a maximum width 151 of between 0.05 and 3 millimeters and a maximum elevation span 153 away from the first surface of between 0.05 millimeters and 3 millimeters.

The knifeback mounting portion 168 may define a second mounting aperture 182 and a second annular section mount 184. The second annular section mount 184 is offset in spaced relation from the second mounting aperture 182. Therefore, the first annular section mount 176 is in surrounding relation of and offset from the first mounting aperture 170 and the second annular section mount 184 is in surrounding relation of and offset from the second mounting aperture 182. The second annular section mount 184 has the same dimensions as the first annular section mount 176.

Typically the sickle cutting sections 106 have a first lateral dimension (width) of between 6 and 9 centimeters, a second later dimension (length) of between 6 and 9 centimeters and the plate thickness 166 is between 2 and 5 millimeters. In other embodiments wherein, there may be a plurality of tips and a plurality of wedge portions, the first lateral dimension (width) may be between 9.5 and 10.5 centimeters (cm). Sickle cutting section 106 may be wider or lager for example, as shown in U.S. Pat. No. 6,467,246 to McCredie, which are also covered by the claims appended hereto.

Typically the sickle cutting sections 106 are not hardened prior to pressing or machining or providing the insert or a clad of the first mounting annular section mount 176 and second annular section mount 184. However, the sickle cutting section 106 may be subject to further hardening such as by heat treatment, In other embodiments no such subsequent heat treatment is provided.

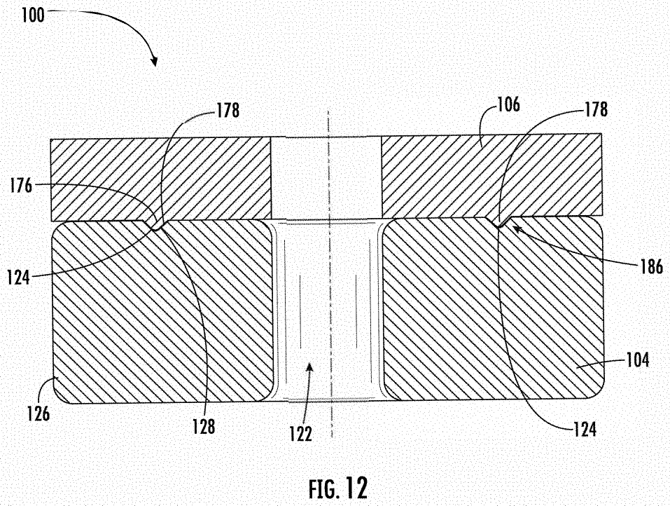

Turning to FIG. 12, a partial vertical cross section of the sickle bar assembly 100 of FIG. 1 is illustrated. The cross section is taken through one of a sick cutting sections 106 and through the knifeback 104 at one of the plurality of bar apertures 122 at the second end 126 of the knife back 104.

The sickle cutting section 106 is mechanically interlocked via its annular mount 124 and the first annular section mount 176 to provide the mechanical interlock 186, section joint, that reduces a bolt load. Indeed, as discussed previously the mechanical interlock 186 reduces a bolt load when a bolt 114 (FIG. 1) is inserted therethrough. While only a single bar aperture 122 is illustrated, the mechanical interlock 186 may be present between each one of the plurality of sickle cutting sections 106 where mounted to the knifeback 104 via the first annular section mounts 176 and second annular section mounts 184 and the plurality of annular mounts 124. Thus, the annular mounts 124 and the first annular section mount 176 and second annular section mounts 184 are complimentary and cooperate to provide the mechanical interlock 186.

It should be readily apparent at this point in the description that the annular mounts 124 having annular channels 128 that receive the knife annular ribs 178 may be reversed such that the annular mounts 124 are ribs (See e.g. 434 at FIG. 8). That is the mechanical interlock can be provided by annular rib tips (See e.g. 434 at FIG. 8) of the knifeback 404 while the sickle cutting sections 106 may provide the knifeback annular channels.

Each annular mount shown in the various embodiments are illustrated to include comprises a radially inwardly facing support surface (e.g. outer wall 132, or inner wall 430) and a radially outward facing support surface (e.g. inner wall 130, or outer wall 432) that are connected at an annular joint (e.g. channel bottom 134, or rib tip 434). Preferably, the radially outward facing support surface and the radially inwardly facing support surface converge toward each other toward the annular joint, such as the case in the V-shaped profiles, but could be other shapes include a U-shaped profile for example.

Similarly, each annular section mount shown in the various embodiments are illustrated to include comprises a radially inwardly facing support surface (e.g. for facing and preferably engaging against outer wall 132, or inner wall 430) and a radially outward facing support surface (e.g. for facing and preferably engaging inner wall 130, or outer wall 432) that are connected at an annular joint (e.g. for facing and optionally engaging or being channel bottom 134, or rib tip 434). Preferably, the radially outward facing support surface and the radially inwardly facing support surface of the sickle sections converge toward each other toward the annular joint, such as the case in the V-shaped profiles, but could be other shapes include a U-shaped profile for example.

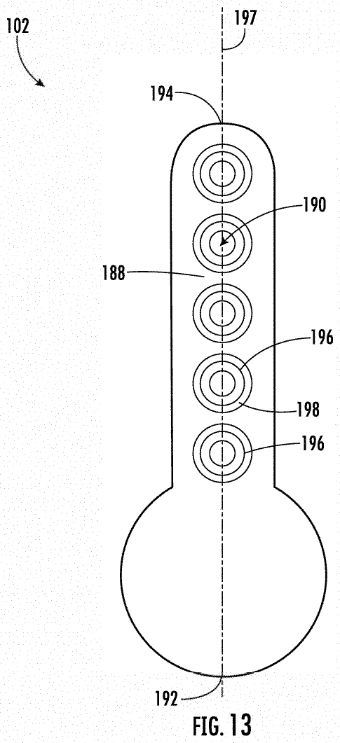

FIG. 13 schematically illustrates the bottom view of the knife head 102 of FIG. 1. Knife head 102 includes a bottom mating surface 188. A plurality of head apertures 190 may extend along the entire length of the knife head 102 from a proximal head end 192 to a distal end 194. A head central longitudinal axis 197 bisects the knife head 102 in extension from the proximal end 192 to the distal end 194. As seen in FIG. 1, the bottom mating surface 188 mates with the second surface (top surface) 160 (FIG. 11) of the sickle cutting section 106 (FIG. 1) or in other embodiments the bottom mating surface 188 may join directly with the first bar surface 110 (FIG. 1) of the knifeback 104 (FIG. 1).

The knife head 102 may have a plurality of head annular mounts 196 that may be annular head channels 198 as described with respect to the plurality of annular channels 128 (FIGS. 3 and 5) or they may be a plurality of annular head ribs as described with respect to the annular rib 528 (FIG. 8). Where the knife head 102 mates over a sickle cutting section 106 (FIG. 1), the second surface 160 of the sickle cutting section 106 (FIG. 11) includes annular mounts, as for example those described with respect to annular mounts 124 (FIGS. 3 and 5) that are complementary to the knife head 102. Thus, the annular mounts 196 may be complimentary to receive or be received by the annular mounts 124 of the sickle bar 104 or first and second annular section mounts as discussed with respect to the first and second annular section mounts 176, 184 (FIG. 11) but along the second surface 160 of the sickle cutting sections 106.

The knife head 102 typically has a length defined between the proximal end 192 to the distal end 194 of between 10 and 122 cm and a thickness of between 0.2 and 5 cm. The knife head 102 may have a width that tapers from the proximal end to the distal end and typically has a width of between 15 to 155 mm. In a preferred embodiment the narrowest width of the knife head 102 is between 15 and 20 mm and the widest width is between 125 and 175 mm. In a more preferred embodiment, the narrowest width is between 16 and 19 mm and the widest width between 140 and 160 mm.

The entire knife head 102, in an embodiment, may be hardened, for example by heat treatment before and then after the cold forming, machining, insertions, or cladding. Alternatively, the knife head 102 may not be hardened before or after the cold forming, machining, insertions, or cladding. Alternatively, the knife head 102 is not hardened before the cold forming or machining, insertion, or cladding but is subject to subsequent hardening to further improve fatigue strength after these processes.

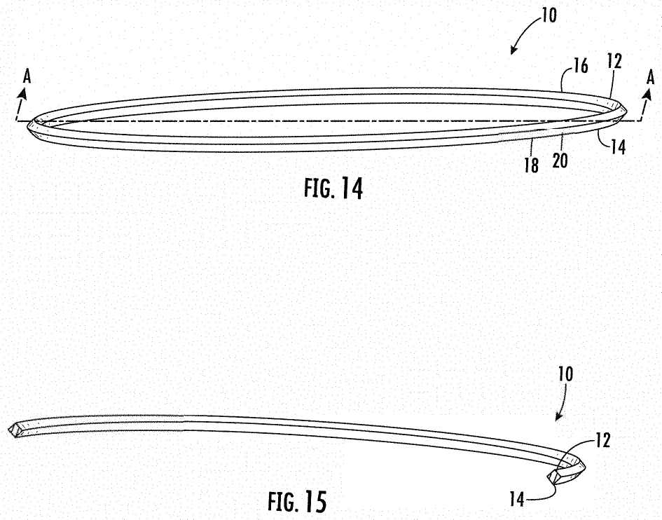

Turning to FIG. 14, FIG. 15, and FIG. 18, an annular insert 10 that can be part of the knifeback 104 (FIG. 3 and FIG. 18) is illustrated. The annular insert 10 is a profiled ring that can serve as the annular mounts. For example, annular insert 10 may be mounted in a member of the annular channels 128 shown in FIG. 2, in removable manner preferably, although permanent installation of the inserts is also contemplated.

The annular inserts 10 in the knifeback bar 116 projects from the annular channels 128 and beyond the first bar surface 110 to provide first annular ribs 12 as the annular mounts 124. Each annular insert 10 includes a second annular rib 14 that projects into and thus is received by annular channel 124 that can also be referred to in this sense as insert channels.

The first and second annular ribs 12, 14 may be considered projecting wedge portions, projecting in opposite directions. Moreover, the first annular rib 12 has a first tip 16 and the second annular rib 14 has a second tip 18. The first and second tips 16, 18 may be pointed or may rounded depending on whether the sickle cutting section 106 has an insert channel 178 that has a rounded channel bottom or a pointed channel bottom as illustrated.

The annular inserts 10 may be removably mounted in the annular channels 128 or alternatively may be fixed in the annular channels 128 by an known technique for example press fit, weldment, bonding adhesive, or laser welded or clad.

FIG. 18 illustrates a mating sickle section 106 having a mating annular section mount 176 having an insert channel 178 for receiving the first annular rib 12 of the first annular insert 10. The knifeback bar 116 receives the second annular rib 14 to provide the mechanical interlock between the knifeback 104 (that includes the first annular insert 10 and knifeback bar 116) and the sickle cutting section 106 when the knifeback 104 and the sickle cutting section 106 are fastened together with bolts, washers and nuts not illustrated but, similar to what is shown in FIG. 1.

Thus, the sickle cutting sections 106 are mounted to the knifeback 104 which includes as a part thereof the annular insert 10 together with the knifeback bar 116 such that a mechanical interlock is formed between the these mating parts and clamped together with fasteners as previously discussed. The annular insert 10 saves on machining costs relative to forming the annular channels 128 with ribs 428 FIG. 8 that may be along the first surface 410 which might interfere with further cold working of the knifeback 104. It can now be readily appreciated that in an embodiment where the annular inserts 10 are removably mounted in the annular channels 128, the knifeback 104 is an assembly of the knifeback bar 116 in combination with the annular inserts 10.

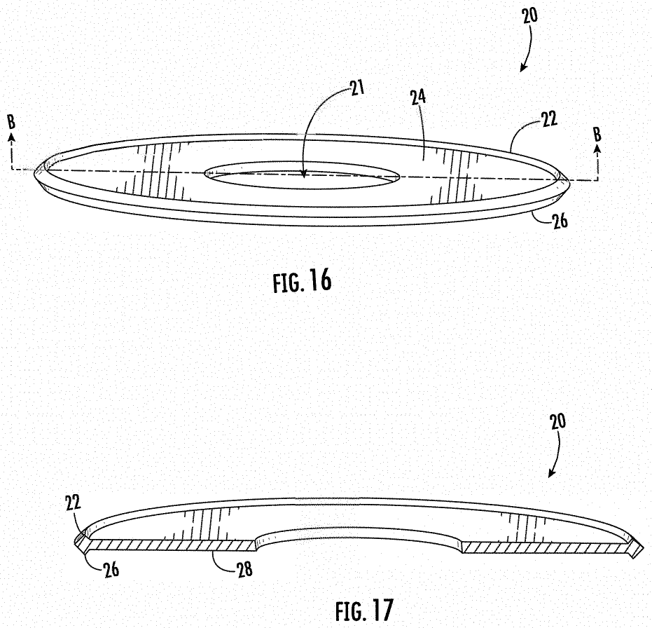

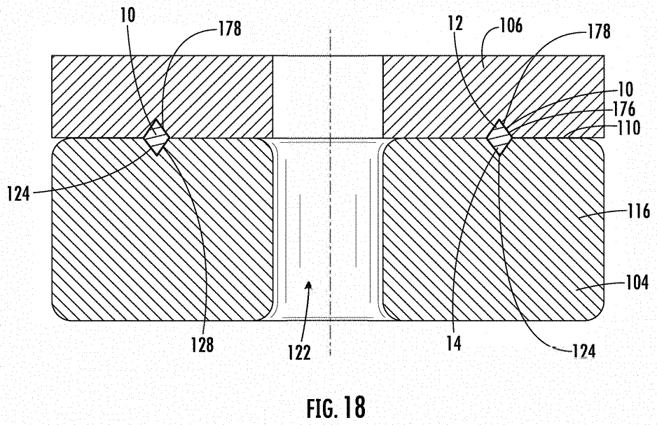

Turning to FIG. 16 and FIG. 17, another embodiment of an insert 20 for the knifeback 104 (FIG. 3, FIG. 18) is illustrated. Instead of the profiled ring 10 here the insert 20 is an annular disc with an aperture 21. The annular disc 20 has at least one annular wedge projection 22 that may be considered a first annular rib. The first annular rib extends from a flat side 24 of the annular disc transversely relative to the first bar surface 110 of the knifeback bar 116 (FIG. 18). The annular disc 20 may have another wedge projection 26 that is a second annular rib projection in the opposite direction of the annular wedge projection 22 and beyond the second flat surface 28 of the annular disc 20. The second annular rib 14 is received into the annular channel 128 of the knifeback bar 116. The annular disc 20 may be removable from the knifeback bar 116 or fixed in or to the knifeback bar 116. So too, sickle cutting sections 106 (FIG. 18) are mounted to the knifeback 104 which includes as a part thereof the annular insert 20 such that a mechanical interlock is formed between the these mating parts and clamped together with fasteners as previously discussed with respect to insert 10 in FIG. 18.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A knifeback for mounting a plurality of sickle cutting sections along a length of the knifeback, the knifeback comprising:
an elongated knifeback bar comprising a first bar surface and a second bar surface;
a plurality of bar apertures extending through the first and second bar surfaces arranged to facilitate side-by-side mounting of the sickle cutting sections;
a plurality of annular mounts along the first bar surface;
wherein each of the annular mounts is offset from and in surrounding relation of a respective member of the plurality bar apertures.

2. The knifeback of claim 1, wherein each of the annular mounts comprises an annular rib, the annular rib having an outer wall and an inner wall connected at a rib tip.

3. The knifeback of claim 1, wherein each of the annular mounts comprises an annular channel having an inner wall and an outer wall connected at a channel bottom.

4. The knifeback of claim 1, wherein each of the annular mounts is a continuous uninterrupted ring structure extending 360 degrees around the respective one of the plurality of bar apertures.

5. The knifeback of claim 1, wherein each of the annular mounts is discontinuous comprising spaced segments in a shape of a ring.

6. The knifeback of claim 1, wherein an innermost location of each annular mount is spaced at least 1 millimeter from an outermost location of the respective one of the plurality of bar apertures.

7. The knifeback of claim 6, wherein along the first bar surface regions radially inside of and outside of each of the annular mounts are coplanar.

8. The knifeback of claim 1, wherein the annular mount comprised a V-shaped cross-section.

9. The knifeback of claim 1, wherein the annular mount comprises a U-shaped cross section.

10. The knifeback of claim 2, wherein each of the annular mounts is sized to be received into complimentary annular channel of a sickle cutting section to provide a mechanical interlock between the knifeback and the sickle cutting section.

11. The knifeback of claim 3, wherein each of the annular mounts is sized to receive a complimentary annular rib of a sickle cutting section to provide a mechanical interlock between the knifeback and the sickle cutting section.

12. The knifeback of claim 1, wherein each of the annular mounts has an outer diameter that is at least 50% more than a diameter of the respective one of the plurality of bar apertures that it surrounds.

13. The knifeback of claim 2, wherein each of the annular ribs has a maximum width of between 0.5 and 3 millimeters and a maximum height measured in a direction extending away from substantially coplanar regions of the first bar surface and the second bar surface of no greater than 50% of a bar thickness between the first bar surface and the second bar surface.

14. The knifeback of claim 3, wherein each annular channel has a maximum width of between 0.5 and 3 millimeters and a maximum depth measured from the first bar surface towards the second bar surface of no greater than 50% of a bar thickness between the first bar surface and the second bar surface.

15. The knifeback of claim 3, wherein the annular channel is cold pressed into the first bar surface or the first bar surface is machined to define the annular channel.

16. The knifeback of claim 2, wherein the annular rib has an outer diameter at least 50% more than an outer diameter of a respective one of the plurality of apertures that it surrounds.

17. The knifeback of claim 2, wherein the annular rib is defined by machining or stamping, or by an insert, or by deposition of a cladding.

18. The knifeback of claim 3, wherein each annular mount has a maximum width of between 0.5 and 3 millimeters and a maximum elevation span away from the first bar surface of between 0.05 millimeters and 1.5 millimeters, and is spaced away from the bar apertures by at least 1 millimeter.

19. The knifeback of claim 1, wherein each annular mount comprises a radially inwardly facing support surface and a radially outward facing support surface that are connected at an annular joint.

20. The knifeback of claim 20, wherein the radially outward facing support surface and the radially inwardly facing support surface converge toward each other toward the annular joint.

21. A knifeback, comprising: an elongated knifeback bar comprising a first bar surface and a second bar surface, the elongated knifeback bar having a drive end and a distal end;
a row of bar apertures extending through the first and second bar surfaces;
a plurality of annular mounts along the first bar surface, the annular mounts comprising: (a) annular channels, or (b) annular ribs, or (c) a combination of annular channels and annular ribs;
a plurality of sickle mounting locations arranged in side by side relation along a length of the elongated knifeback bar, each sickle mounting location comprising at least one annular mount and at least one bar aperture.

22. The knifeback of claim 21, wherein each annular mount is in surrounding relation of a respective member of the bar apertures.

23. The knifeback of claim 21, wherein the annular mounts are offset in spaced relation from the bar apertures.

24. The knifeback of claim 21, wherein each sickle mounting location comprises two of the bar apertures and two of the annular mounts including a first mount surrounding a first bar aperture, and a second mount surrounding a second bar aperture.

25. The knifeback of claim 21, wherein the drive end comprises drive mounting apertures, wherein a portion of the drive end with at least some of the drive mounting have the annular mounts.

26. A sickle bar assembly comprising the knifeback of claim 21 in combination with a plurality of sickle cutting sections, each of the sickle cutting section having a first annular section mount and further comprising a plurality of fasteners, at least one of the plurality of fasteners secures a corresponding member of the plurality of sickle cutting sections to the sickle bar, each corresponding member of the plurality of the sickle cutting sections being mechanically interlocked via the annular mount and the first annular section mount.

27. The sickle bar assembly of claim 26, wherein the first surface includes cold formed and plastically deformed rounded bearing surfaces at the opening of each one of the plurality of bar apertures at the first bar surface to reduce a bolt load when a bolt is inserted therethrough.

28. The sickle bar assembly of claim 26, wherein each the first annular section mounts has a maximum width of between 0.05 and 3 millimeters and a maximum elevation span away from the first surface of between 0.05 millimeters and 3 millimeters.

29. A sickle cutting section, comprising:
a sickle plate comprising a first surface and a second surface, the sickle plate extending forwardly between an end of the sickle plate to a tip of the sickle plate with a plate thickness being defined between the first surface and the second surface;
the sickle plate including a knifeback mounting portion extending a partial distance from the end toward the tip with the knifeback mounting portion defining a first mounting aperture, and a wedge portion extending from the mounting portion to the tip of the plate, the wedge portion defining a pair of knife cutting edges on opposite sides of the wedge portion that converge toward the tip;
wherein the first surface of the plate along the knifeback mounting portion comprises at least one annular section mount that includes a first annular section mount, offset in spaced relation from the first mounting aperture.

30. The sickle cutting section of claim 29, wherein the first annular section mount comprises an annular rib.

31. The sickle cutting section of claim 29, wherein the first annular section mount comprises an annular channel.

32. The sickle cutting section of claim 29, wherein the first annular section mount is in surrounding relation of the first mounting aperture.

33. The sickle cutting section of claim 29, wherein the knifeback mounting portion defines a second mounting aperture and a second annular section mount, the second annular section mount being offset in spaced relation from the second mounting aperture.

34. The sickle cutting section of claim 33, wherein the first annular section mount is in surrounding relation of and offset from the first mounting aperture, and wherein the second annular section mount is in surrounding relation of and offset from the second mounting aperture.

35. The sickle cutting section of claim 29, wherein each annular section mount comprises a radially inwardly facing support surface and a radially outward facing support surface that are connected at an annular joint.

36. The sickle cutting section of claim 35, wherein the radially outward facing support surface and the radially inwardly facing support surface converge toward each other toward the annular joint.

37. The knifeback of claim 1, wherein the annular mounts are provided by annular inserts, and wherein annular channels are defined into the first bar surface, with each annular insert mounted in a member of the annular channels.

38. The knifeback of claim 37, wherein the annular inserts project from the annular channels and beyond the first bar surface to provide annular ribs as the annular mounts.

39. The knifeback of claim 37, wherein the annular inserts are removably mounted in the annular channels, wherein the knifeback comprises an assembly of the knifeback bar in combination with the annular inserts.

40. The knifeback of claim 37, wherein each annular insert comprises a disc comprising at least one annular wedge projection extending from at least one of opposed flat sides of the flat annular disc transversely relative to the first bar surface, and optionally both opposed flat sides.

41. The knifeback of claim 37, wherein each annular insert comprises a profiled ring comprising upper and lower annular wedge projections projecting transversely relative to the first bar surface.

42. The knifeback of claim 21, wherein the annular mounts are provided by annular inserts at the mounting locations, and wherein annular insert channels are defined into the first bar surface, with each annular insert mounted in a member of the annular insert channels.

43. The knifeback of claim 42, wherein the annular inserts project from the annular insert channels and beyond the first bar surface to provide said annular ribs as the annular mounts.

44. The knifeback of claim 42, wherein the annular inserts are removably mounted in the annular insert channels, wherein the knifeback comprises an assembly of the knifeback bar in combination with the annular inserts.

45. The knifeback of claim 42, wherein each annular insert comprises a disc comprising at least one annular wedge projection extending from at least one of opposed flat sides of the flat annular disc transversely relative to the first bar surface, and optionally both opposed flat sides.

46. The knifeback of claim 42, wherein each annular insert comprises a profiled ring comprising upper and lower annular wedge projections projecting transversely relative to the first bar surface.
